(19) United States
(12) Patent Application Publication
(10) Pub. No.: US 2025/0016551 A1
(43) Pub. Date: Jan. 9, 2025

(54) SYSTEM AND METHOD FOR TEMPORARY PROVISIONING OF ESIM PROFILE ON A SECONDARY DEVICE

(71) Applicant: LexAnalytico consulting private limited, Bengaluru (IN)

(72) Inventor: Gyanveer Singh, Karnataka (IN)

(21) Appl. No.: 18/762,723

(22) Filed: Jul. 3, 2024

(30) Foreign Application Priority Data
Jul. 3, 2023 (IN) 202341044500

(51) Int. Cl. H04W 8/26; H04W 8/18; H04W 12/069; H04W 12/72

(52) U.S. Cl. CPC H04W 8/265; H04W 8/183; H04W 12/069; H04W 12/72

(57) ABSTRACT

A method for temporary remote provisioning of an electronic Subscriber Identity Module (eSIM) profile on a secondary device is disclosed. The method includes receiving a request from a user to temporarily provision the eSIM profile on the secondary device and authenticating user's identity by verifying user credentials via an authentication server. Next, the method includes suspending the eSIM profile on a primary device upon successful authentication and downloading the eSIM profile, to the secondary device, from a subscription management server that is configured to manage eSIM profile provisioning. Thereafter, the method includes activating the eSIM profile on the secondary device for a specific interval based on a predefined condition.

### CROSS-REFERENCE

This application is related to and claims priority to Indian Provisional Application No. 202341044500, filed on Jul. 3, 2023, and titled “SYSTEM AND METHOD FOR TEMPORARY PROVISIONING OF ESIM PROFILE ON A SECONDARY DEVICE”, which is hereby incorporated by reference in its entirety.

### BACKGROUND

### Technical Field

The present disclosure relates to the field of Electronic-Subscriber Identity Module (e-SIM), and particularly relates to a system and method for temporary provisioning of e-SIM profile on a secondary device.

### Description of the Related Art

In the past, telephones were associated with specific locations and were tethered to such locations with wires that prevented meaningful mobility. It was then understood that any telephone call was made to a specific location (e.g., an office or a family home) rather than to a specific person. A person with whom one wished to converse could be called only if present at the called location, at the very time of the call.

With the coming of mobile telephony, the paradigm of calling changed from calling a location to calling a mobile number. The mobile number has become the identity of a user. However, the mobile number got very much tied to a mobile device because of a physical SIM (subscriber identity module) card. Accordingly, removing and entering the physical SIM is a multi-step process and requires the user to have the physical SIM in possession if the user want to use the same number on another device. These SIM cards typically are small integrated circuit (IC) “smart” cards that fit into a slot inside an extendable tray in a mobile device. The SIM card carries the user's information and is used to authenticate the mobile device in which it is placed as belonging to the user. A cellular network recognizes the SIM credentials and provides voice and data services as subscribed by the user, to the mobile device in which it is placed. In the early days, if users had multiple devices, they needed multiple numbers. To address the need of the user who wished to use the same mobile number on multiple devices, some solutions were proposed. One such solution is disclosed in the U.S. Pat. No. 7,680,491 B2 that describes a method and system allowing for one mobile phone number (MSISDN) to be associated with a plurality of wireless devices. Such a system enables multiple independent SIMs (e.g., with individual IMSIs (International Mobile Station Identifiers)) to utilize the same phone number (MSISDN) to provide telephony services via a macroscopic (GSM) carrier. The inherent issue with this type of solution is the need for having multiple physical SIM cards configured with the same phone number and the user needs to get multiple SIM cards issued from the carrier. To overcome the need to have multiple physical SIMs, there were solutions proposed that enabled the creation of virtual SIMs (V-SIM) that, however, required the primary device holding the physical SIM to be in proximity to the second device on which V-SIM is provisioned. For example, U.S. Pat. No. 9,853,670B2 discloses a system and method for twinning a SIM that is configured to initiate transmission of an entrance notification to a carrier network server notifying that the primary UE entered the vehicle. The system is configured to receive an assignment message from the carrier network server. The assignment message indicates that twinning has been configured between the primary UE and the apparatus. The twinning configuration includes a transfer of assignment of a service plan corresponding to the primary UE from the primary UE to the apparatus. For such a system to work, the primary UE (mobile phone) has to be in the proximity of the user. However, the primary UE may not be available always and thus such systems may fail.

To remove the limitation of primary UE to be in proximity, there were some solutions proposed, which enabled the users to have the same data plan across multiple devices, so that the user can stay connected on their smartwatches, tablets, or other devices without Wi-Fi or their having their phone nearby. One such solution is Vodafone OneNumber® but the issue with this solution is the need to have the primary device always active, as it routes the call to other devices over the data network through the primary device, such that if the primary device is off, the calls may not be routed to other devices. Therefore, such a solution is not suitable when the primary device battery is drained or intentionally switched off. Accordingly, all the existing solutions require pre-configuration of a fixed set of trusted devices as being mapped to a specific number and/or carrying multiple SIMs to obtain the service available to a mobile number across multiple devices.

Thus, there is a requirement for a system and method for temporary provisioning of e-SIM profile on a secondary device to overcome the limitation of the prior art references.

### BRIEF SUMMARY

One or more embodiments are directed to a system and a method (may together be termed as ‘mechanism’) for temporary remote provisioning of an electronic Subscriber Identity Module (eSIM) profile on a secondary device. The mechanism uses eSIMs and secure, dynamic provisioning of credentials, to permit use of a non-personal device (e.g., one belonging to a friend) to temporarily be able to make and receive calls as a user-1, metering of such calls and related usage based on plans and access available to the user-1, the use of eSIMs to dynamically provision credentials of user-1 onto whichever device is available to the user at the time, the availability of various new technologies as well as market models, for making devices and personalized calling facilities available to users, no concurrent usage of eSIM profile, and the use of cloud services and networked storage for secure availability of calling history, text messages, contacts, personal messages, and other associated data needed by a user.

In an embodiment, the mechanism temporarily configures the eSIM of a user-1 on any non-personal calling device having GSM support, for example, a mobile device of a user-2 (lender) to allow user-1 to make calls using corresponding number from the non-personal calling device. The proposed mechanism may be implemented in the form of an application or integrated with a native operating system (e.g., Android OS, iOS, etc.) to allow a third-party call by a borrower. In an embodiment, the mechanism may be accessed even when the non-personal device (e.g., the mobile phone) is locked, like an emergency dialer. In operation, initially, upon selecting the option, the user-1 may be prompted to share his credentials (e.g., biometric-id, facial-id, voice-id, user-id, etc.), that may be verified by a primary authenticator, such as device OS provider (e.g., Apple, Google, Samsung, etc.). Once the user identity (e.g., Apple ID, Google ID, Samsung ID, etc.) is obtained based on the user credentials, a mobile number associated with the user-id may be obtained by the mechanism. The mechanism may further identify the carrier-id (service provider ID) for the mobile number and initiate a request to temporarily provision the e-SIM on the non-personal device (a device of user-2). As user-1 is authenticated, an authentication certificate obtained from the primary authenticator may be sent to the carrier/operator. The carrier/operator can perform its authentication based on the shared credentials (e.g., biometric-id, facial-id, voice-id, etc.), and upon successful authentication push the eSIM configuration data to the non-personal device (a device of user-2). It may be apparent to a person skilled in the art that other alternate ways to authenticate the user may also be used, without departing from the scope of the present disclosure.

Upon, authentication of the user-1, a lite version of the user profile data and contact list may be downloaded to the mobile device. In an embodiment, such lite version of the user profile may, without any limitation, include just the username, photo, and lite version of the contact list (without images of each contact). In some cases, an application may be downloaded based on user request. From the lite version of the user profile, user-1 will be able to see his contacts and dial a number saved in the contact list along with recently dialed and received numbers. Further, when a call is initiated, the mobile number associated with user-1 will be used. and the mobile number of user-2 is not used, thus, the identity of user-2 is secured. By using the eSIM, a person receiving the call will be displayed with the details of the user-1 as saved by such person, and no details of the user-2 are provided or sent to the called person. Thus, the person receiving the call can see the identity of user-1 as the calling user and hence can decide to accept or deny the call. In an embodiment, the call can be allowed based on the subscription and available recharge associated with a registered number of the first user only. It may be apparent to a person skilled in the art that no charge will be applicable for the phone number of user-2.

In an embodiment, the application may limit its usage to avoid its misuse. To limit misuse, the system may limit the frequency of the calls, the duration of the calls, and/or the time for which the eSIM is temporarily configured. For example, the system may allow user-1 to make only 5 calls or calls for up to 15 minutes in total, or it may revert to user-2's eSIM provisioning after 15 minutes. For making an additional call, user-2 must unlock the mobile phone after a fixed number of calls or a fixed duration. In an embodiment, the users can always enable or disable the third-party call option on their personal devices. However, the system may provide an incentive to enable third-party calls by promising reciprocal privileges, such as, the system may check if user-1 has enabled the third-party call feature on personal mobile device and may process user-1 requests only if user-1 has enabled third-party calls on personal mobile device.

In an embodiment, the system may suspend the eSIM profile of user-1 on device-1 (primary device) before provisioning the eSIM profile on device-2. While receiving the request for eSIM provisioning on device-2, the system may request user-1 to provide the primary device ID (e.g., iPhone, tablet, etc.) on which the eSIM profile needs to be suspected. If there are more than one device on which the eSIM profile of user-1 is active, the system needs to know the specific device on which the eSIM profile must be suspended. The system may also determine the device ID for suspending on the eSIM profile based on the nature of the device-2 or the intended task the user wants to perform on the device-2. The device that matches the profile of device-2 can be selected for suspending the eSIM profile. In an example, the system may also receive from the user-1 a time limit for which the eSIM profiled needs to be provisioned on device-2. In another example, the user-2 can also provide a time limit for which the device-2 can be used by user-1. Accordingly, the system may suspend the eSIM profile of user-1 on device-1 and provision the profile on device-2 only for the time limit. In an embodiment, on expiry of the time limit or a call back from the primary user of the device-2, the system may suspend the eSIM profile of the user-1 on device-2.

An embodiment of the present invention discloses a system for temporary remote provisioning of an electronic Subscriber Identity Module (eSIM) profile on a secondary device. The eSIM profile includes operator credentials, subscriber data, and/or SIM-based applications. Further, a primary device and the secondary device communicate via a secure channel to ensure data integrity during the eSIM profile transfer. Each of the primary device and the secondary device is selected from a group consisting of a mobile phone, tablet, car infotainment system, and/or any connected device with an eSIM slot.

In an embodiment, the system includes a receiving module to receive a request from a user to temporarily provision the eSIM profile on the secondary device. In an embodiment, the system includes an authentication module to authenticate user's identity by verifying user credentials via an authentication server. The authentication module prompts the user, on the secondary device, for additional credentials and/or biometric verification before provisioning the eSIM profile. The authentication server verifies user credentials through one or more verification techniques including password, PIN, biometric identification, and/or security questions. In an embodiment, the system includes a suspension module to suspend the eSIM profile on a primary device upon successful authentication. In an embodiment, the system includes a profile download module to download the eSIM profile, to the secondary device, from a subscription management server that is configured to manage eSIM profile provisioning.

In an embodiment, the system includes a profile activation module to activate the eSIM profile on the secondary device for a specific interval based on a predefined condition. The profile activation module further deactivates and deletes the eSIM profile from the secondary device and reactivates the eSIM profile on the primary device upon expiration of the specific interval. Further, the predefined condition includes a data consumption limit, a number of incoming/outgoing calls, a user-specified time limit, or a combination of. The profile activation module suspends the eSIM profile of a second user on the secondary device if the secondary device has limited eSIM profile slots available.

In an embodiment, the system includes a user interface module to facilitate the user, on the primary device, to specify conditions for profiling eSIM on the secondary device. The user interface module notifies the user, on the primary device, when the predefined condition for the temporary eSIM profile provisioning on the secondary device set to expire. Further, the user interface module facilitates the user, on the primary device, to control actions associated with the temporary eSIM profiling on the secondary device. The actions include at least one of enabling SMS, enabling calls, enabling data services, receiving one-time passwords for financial transactions, and accessing office resources.

An embodiment of the present invention discloses a method for temporary remote provisioning of an electronic Subscriber Identity Module (eSIM) profile on a secondary device. The method includes the steps of a receiving module to receive a request from a user to temporarily provision the eSIM profile on the secondary device. Further, the method includes the steps of authenticating user's identity by verifying user credentials via an authentication server. The method also includes the steps of prompting the user, on the secondary device, for additional credentials and/or biometric verification before provisioning the eSIM profile. The authentication server verifies user credentials through one or more verification techniques including password, PIN, biometric identification, and/or security questions. Next, the method includes the steps of suspending the eSIM profile on a primary device upon successful authentication. The method also includes the steps of downloading the eSIM profile, to the secondary device, from a subscription management server that is configured to manage eSIM profile provisioning.

Thereafter, the method includes the steps of activating the eSIM profile on the secondary device for a specific interval based on a predefined condition. The method also includes the steps of deactivating and deleting the eSIM profile from the secondary device and reactivating the eSIM profile on the primary device upon expiration of the specific interval. Further, the predefined condition includes a data consumption limit, a number of incoming/outgoing calls, and/or a user-specified time limit. Also, the method includes the steps of suspending the eSIM profile of a second user on the secondary device if the secondary device has limited eSIM profile slots available.

Additionally, the method includes the steps of facilitating the user, on the primary device, to specify conditions for profiling eSIM on the secondary device. Further, the method includes notifying the user, on the primary device, when the predefined condition for the temporary eSIM profile provisioning on the secondary device is set to expire. The method also includes facilitating the user, on the primary device, to control actions associated with the temporary eSIM profiling on the secondary device. The actions include at least one of enabling SMS, enabling calls, enabling data services, receiving one-time passwords for financial transactions, and accessing office resources.

The features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary environment having a system for temporary remote provisioning of an electronic Subscriber Identity Module (eSIM) profile on a secondary device, in accordance with an embodiment of the present disclosure.

FIG. 2 illustrates a block diagram of the system for temporary remote provisioning of the eSIM profile on the secondary device, in accordance with an embodiment of the present disclosure.

FIG. 3A-C illustrates example screens of the secondary user device to enable guest mode, in accordance with an embodiment of the present disclosure.

FIG. 4 illustrates an example screen with an option for third-party calls on the locked screen, in accordance with an embodiment of the present disclosure.

FIG. 5A-C illustrate example screens for operation profile installation on the secondary user device, in accordance with an embodiment of the present disclosure.

FIG. 6A-C illustrate example screens for operation profile selection on the secondary user device, in accordance with an embodiment of the present disclosure.

FIG. 7 illustrates a sequence diagram of the system for temporary remote provisioning of the eSIM profile on the secondary device, in accordance with an embodiment of the present disclosure.

FIG. 8A-C illustrates an example eSIM profile provisioning interface, in accordance with an embodiment of the present disclosure.

FIG. 9A illustrates an example eSIM configuration on a call handler phone, in accordance with an embodiment of the present disclosure.

FIG. 9B illustrates an example of an eSIM transfer request initiated by call handler-1 and eSIM configuration by call handler-2, in accordance with an embodiment of the present disclosure.

FIG. 10 illustrates an example of temporarily eSIM provisioning on the second device and auto deactivation when the set limit exceeds, in accordance with an embodiment of the present disclosure.

FIG. 11 is a flow chart of a method for temporary remote provisioning of an electronic Subscriber Identity Module (eSIM) profile on a secondary device, in accordance with an embodiment of the present disclosure.

FIG. 12 illustrates an exemplary computer unit in which or with which embodiments of the present disclosure may be utilized.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, stops may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise. The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to a system and method (together referred to as ‘disclosed mechanism’) for temporary remote provisioning of an electronic Subscriber Identity Module (eSIM) profile on a secondary device. The mechanism uses eSIMs and secure, dynamic provisioning of credentials, to permit use of a non-personal device (e.g., one belonging to a friend) to temporarily be able to make and receive calls as a user-1, metering of such calls and related usage based on plans and access available to the user-1, the use of eSIMs to dynamically provision credentials of user-1 onto whichever device is available to the user at the time, the availability of various new technologies as well as market models, for making devices and personalized calling facilities available to users, no concurrent usage of eSIM profile, and the use of cloud services and networked storage for secure availability of calling history, text messages, contacts, personal messages, and other associated data needed by a user.

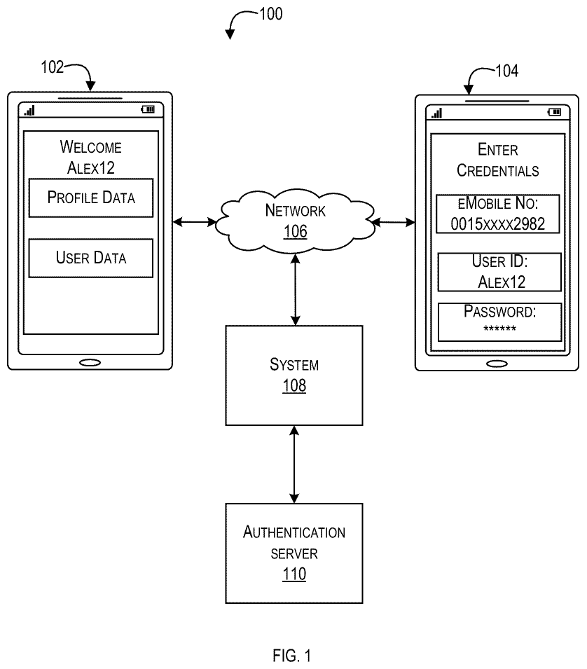

FIG. 1 illustrates an exemplary environment 100 having a system 108 for temporary remote provisioning of an electronic Subscriber Identity Module (eSIM) profile on a secondary device 104, in accordance with an embodiment of the present disclosure.

In an embodiment, the exemplary environment 100 may include a secondary device 102 (may also be termed as user device-2), a primary device 104 (may also be termed as user device-1), a network 106, the system 108, and an authentication server 110. In an embodiment, the eSIM profile may, without any limitation, include operator credentials, subscriber data, and/or SIM-based applications. In an embodiment, the primary device 104 may be associated with a first user/primary user that may need to log in to the corresponding eSIM profile in another non-personal user device i.e. the secondary user device 102 belonging to a second user/secondary user. Each of the primary device 104 and the secondary device 102 may be selected from a group consisting, without any limitation, of a mobile phone, tablet, car infotainment system, and/or any connected device with an eSIM slot. Also, the primary device 104 and the secondary device 102 may communicate via a secure channel, provided by the network 106, to ensure data integrity during the eSIM profile transfer. The network 106 (such as a communication network), may, without any limitation, include a direct interconnection, a Local Area Network (LAN), a Wide Area Network (WAN), a wireless network (e.g., using Wireless Application Protocol), the Internet, and the like.

In an embodiment, the system 108 temporarily configures the eSIM of the primary device 104 on any non-personal calling device having GSM support, for example, a mobile device of the secondary device 102 to allow the primary user to make calls using the corresponding number from the non-personal calling device. The system 108 may be implemented in the form of an application or integrated with a native operating system (e.g., Android OS, iOS, etc.) to allow a third-party call by a borrower. In an embodiment, the system 108 may be accessed even when the non-personal device (e.g., the mobile phone) is locked, like an emergency dialer. In operation, initially, upon selecting the option, the primary user may be prompted to share his credentials (e.g., biometric-id, facial-id, voice-id, user-id, etc.), that may be verified by a primary authenticator, such as device OS provider (e.g., Apple, Google, Samsung, etc.). Once the user identity (e.g., Apple ID, Google ID, Samsung ID, etc.) is obtained based on the user credentials, a mobile number associated with the user-id may be obtained by the system 108. The system 108 may further identify the carrier-id (service provider ID) for the mobile number and initiate a request to temporarily provision the e-SIM on the secondary device 102. As the primary user is authenticated, via the authentication server 110, an authentication certificate obtained from the primary authenticator may be sent to the carrier/operator that may perform authentication based on the shared credentials (e.g., biometric-id, facial-id, voice-id, etc.). Upon successful authentication, the eSIM configuration data may be pushed to the secondary device 102. It may be apparent to a person skilled in the art that other alternate ways to authenticate the user may also be used, without departing from the scope of the present disclosure.

Upon, authentication of the primary user, a lite version of the user profile data and contact list may be downloaded to the secondary device 102. In an embodiment, such lite version of the user profile may, without any limitation, include just the username, photo, and lite version of the contact list (without images of each contact). In some cases, an application may be downloaded based on user request. From the lite version of the user profile, the primary user may be able to see contacts and dial a number saved in the contact list along with recently dialed and received numbers. Further, when a call is initiated, the mobile number associated with the primary user may be used and the mobile number of the secondary user may not be used, thus, the identity of the secondary user is secured. By using the eSIM, a person receiving the call will be displayed with the details of the primary user as saved by such person, and no details of the secondary user may be provided or sent to the called person. Thus, the person receiving the call may see the identity of the primary user as the calling user and hence may decide to accept or deny the call. In an embodiment, the call may be allowed based on the subscription and available recharge associated with a registered number of the primary user. It may be apparent to a person skilled in the art that no charge will be applicable for the phone number of the secondary user.

In an embodiment, the application may limit its usage to avoid its misuse. To limit misuse, the system 108 may limit the frequency of the calls, the duration of the calls, and/or the time for which the eSIM is temporarily configured. For example, the system 108 may allow the primary user to make only 5 calls or calls for up to 15 minutes in total, or it may revert to the secondary user's eSIM provisioning after 15 minutes. For making an additional call, the secondary user must unlock the mobile phone after a fixed number of calls or a fixed duration. In an embodiment, the secondary user may enable or disable the third-party call option on the secondary device 102, however, the system 108 may provide an incentive to enable third-party calls by promising reciprocal privileges, such as, the system 108 may check if the primary user has enabled the third-party call feature on the primary device 104 and may process the primary user's requests only if the primary user has enabled third-party calls on the primary device 104.

In an embodiment, the system 108 may suspend the eSIM profile of the primary user on the primary device 104 before provisioning the eSIM profile on the secondary device 102. While receiving the request for eSIM provisioning on the secondary device 102, the system 108 may request the primary user to provide the primary device ID (e.g., iPhone, tablet, etc.) on which the eSIM profile needs to be suspected. If there are more than one device on which the eSIM profile of the primary user is active, the system 108 may need to know the specific device on which the eSIM profile must be suspended. The system 108 may also determine the device ID for suspending on the eSIM profile based on the nature of the secondary device 102 or the intended task the user wants to perform on the secondary device 102. The device that matches the profile of the secondary device 102 may be selected for suspending the eSIM profile. In an example, the system 108 may also receive, from the primary user, a time limit for which the eSIM profile needs to be provisioned on the secondary device. In another example, the secondary user may also provide a time limit for which the secondary device 102 may be used by the primary user. Accordingly, the system 108 may suspend the eSIM profile of the primary user on the primary device 104 and provision the profile on the secondary device 102 only for the provided time limit. In an embodiment, on expiry of the time limit or a call back from the primary user of the secondary device 102, the system 108 may suspend the eSIM profile of the primary user on the secondary device 102.

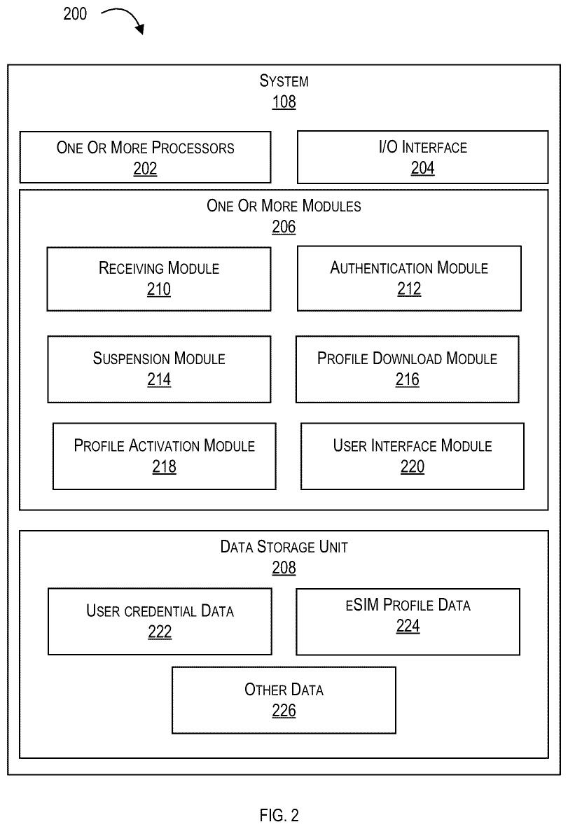

FIG. 2 illustrates a block diagram 200 of the system 108 for temporary remote provisioning of the eSIM profile on the secondary device 104, in accordance with an embodiment of the present disclosure.

In an embodiment, the system 108 may include one or more processors 202, an Input/Output (I/O) interface 204, one or more modules 206, and a data storage unit 208. The one or more processors 202 may be implemented as one or more microprocessors microcomputers, microcomputers, digital signal processors, central processing units, state machines, logic circuitries, and/or any devices that manipulate signals based on operational instructions. Further, the I/O interface 204 may serve as the pivotal bridge connecting the internal processes of the system 108 with its external environment for facilitating the exchange of information between the system 108 and its users or external devices. Furthermore, the I/O interface 204 may contribute to the user experience by providing intuitive means for input, such as through keyboards or touchscreens, and presenting meaningful output via displays or other output devices. In an embodiment, the one or more modules 206 may include a receiving module 210, an authentication module 212, a suspension module 214, a profile download module 216, a profile activation module 218, a user interface module 220, and any other module essential or required for the working of the system 108. In an embodiment, the data storage unit 208 may include the user credential data 222 eSIM profile data 224, and any other data 226 required for the working of the system 108. In an embodiment of the present disclosure, the one or more processors 202 and the data storage unit 208 may form a part of a chipset installed in the system 108. In another embodiment of the present disclosure, the data storage unit 208 may be implemented as a static memory or a dynamic memory. In an example, the data storage unit 208 may be internal to the system 108, such as an onside-based storage. In another example, the data storage unit 208 may be external to the system 108, such as cloud-based storage. Further, the one or more module 206 may be communicatively coupled to the data storage unit 208 and the one or more processor 202 of the system 108. The one or more processors 202 may be configured to control the operations of the one or more modules 206.

In an embodiment, the receiving module 210 may receive a request from the primary user (hereafter may be termed as ‘user’) to temporarily provision the eSIM profile on the secondary device 102 that may be associated with the secondary user (hereafter may be termed as ‘lender’). The receiving module 210 may validate the format and completeness of the request data, ensuring that it includes essential details such as user identification, the primary device's identifier, and the secondary device's specifications. In an embodiment, the receiving module 210 may ensure that all incoming requests are transmitted over secure channels to prevent unauthorized access or tampering, such as by using encryption protocols and secure sockets to safeguard the data during transmission. Additionally, the receiving module 210 may be able to detect and mitigate potential security threats, such as denial-of-service attacks or phishing attempts, which could compromise the system's integrity, without departing from the scope of the disclosure. In an embodiment, the receiving module 210 may interact with the user interface module 220, that may collect and/or forward user requests to ensure that the user's request is accurately captured and any user-specified conditions for the eSIM provisioning, such as data limits, call restrictions, or time constraints, are properly documented and forwarded to the relevant system components. The working of the user interface module 220 has been discussed in detail in the following paragraphs.

In an embodiment, the authentication module 212 may authenticate the user's identity by verifying user credentials data 222 via the authentication server 110 to ensure that the user requesting the eSIM profile provisioning is legitimate and authorized to make such a request. In an embodiment, the authentication module 212 may prompt the user, on the secondary device 102, for additional credentials and/or biometric verification before provisioning the eSIM profile. For authentication, the authentication server 110 may verify user credentials through one or more verification techniques including, without any limitation, password, PIN, biometric identification, and/or security questions. It may be apparent to a person skilled in the art that the authentication server 110 may cross-reference the user credential data with a secure database containing registered user data to confirm the authenticity of the user and prevent fraudulent activities. Accordingly, if the user credentials are verified successfully, the authentication module 212 may grant permission for the eSIM profile provisioning to proceed and if the user credentials do not match then the user may be prompted to re-enter the information and/or undergo additional verification steps. In an embodiment, the authentication module 212 may also manage user sessions to ensure that once a user is authenticated, the session remains secure throughout the eSIM provisioning process, such as by maintaining secure communication channels and periodically re-authenticating the user during extended sessions to prevent session hijacking.

In an embodiment, the suspension module 214 may suspend the eSIM profile on the primary device 104 upon successful authentication by the authentication server 110. It may be apparent to a person skilled in the art that this suspension may be crucial to ensure that the eSIM profile is not simultaneously active on both the primary device 104 and secondary device 102, which could lead to, without any limitation, network conflicts and potential security vulnerabilities. Accordingly, the suspension module 214 may handle various scenarios and conditions for suspension. For instance, the suspension module 214 may be programmed to automatically suspend the eSIM profile on the primary device 104 based on predefined conditions, such as the initiation of profile activation on the secondary device 102 and/or the suspension module 214 may manage multiple profiles, making it versatile in environments where a user might switch between several devices. In an embodiment, the suspension module 214 may also support conditional suspension, where the suspension of the eSIM profile on the primary device 104 is triggered by specific events and/or user-defined criteria. For example, a user might specify that the primary device's eSIM profile should only be suspended if the secondary device 102 is within a certain geographical location and/or connected to a specific network.

In an embodiment, the profile download module 216 may download the eSIM profile data 224, to the secondary device 102, from a subscription management server (not shown) that may be configured to manage eSIM profile provisioning. The subscription management server may be responsible for securely managing, storing, and distributing eSIM profiles to authorized devices. Further, the subscription management server may ensure that the eSIM profile includes all necessary operator credentials, subscriber data, and SIM-based applications, maintaining data integrity and security throughout the transfer process. It may be noted that the download process is initiated after the system 108 receives the necessary authorization, ensuring that the eSIM profile transfer is both secure and efficient and the profile download module 216 may use secure channels to prevent any data breaches or unauthorized access during the download, maintaining the confidentiality and integrity of the user's information. In an embodiment, the profile download module 216 may handle various network conditions and may be designed to operate efficiently over different types of connections, such as Wi-Fi, LTE, or 5G to ensure that the profile download process is smooth and uninterrupted. Additionally, the profile download module 216 may also support resumable downloads, such that in case of a network interruption, the download may resume from where it left off, preventing any loss of data and saving time for the user. Additionally, the profile download module 216 may be integrated with other systems and services to provide a seamless user experience. For example, the profile download module 216 may interact with Mobile Device Management (MDM) systems to automate the download and provisioning process in enterprise environments to ensure that employees quickly and securely provision their eSIM profiles on corporate devices, adhering to the organization's security policies and protocols.

In an embodiment, the profile activation module 218 may activate the eSIM profile on the secondary device 102 for a specific interval based on a predefined condition set by the primary user, allowing the user to access cellular services such as voice calls, SMS, and data connectivity. Further, the predefined condition may include, without any limitation, a data consumption limit, a number of incoming/outgoing calls, and/or a user-specified time limit. The setting of the predefined conditions may be discussed in detail in the following paragraphs. The profile activation module 218 may be designed to handle various activation scenarios, including automatic activation upon download completion or manual activation triggered by the user through a user interface. Accordingly, the profile activation module 218 may allow users to control when the eSIM profile becomes active, catering to different usage needs and preferences. In an embodiment, the profile activation module 218 may deactivate and delete the eSIM profile from the secondary device 102 and reactivate the eSIM profile on the primary device 104 upon expiration of the predefined condition, such as the specific interval. Accordingly, the profile activation module 218 may ensure that the temporary provisioning is strictly enforced, reverting the secondary device 102 back to its original state and reactivating the eSIM profile on the primary device 104. It may be apparent to a person skilled in the art that this feature may be particularly useful in scenarios where temporary use is required, such as traveling or testing new services, as it provides peace of mind that the primary device's profile will be restored without manual intervention. Additionally, the profile activation module 218 may suspend the eSIM profile of the secondary user (also termed as second user) on the secondary device 102 if the secondary device 102 has limited eSIM profile slots available.

In an embodiment, the user interface module 220 may facilitate the user, on the primary device 104, to specify conditions for profiling eSIM on the secondary device 102. Further, the user interface module 220 may notify the user, on the primary device 104, when the predefined condition for the temporary eSIM profile provisioning on the secondary device 102 is set to expire. Additionally, the user interface module 220 may facilitate the user, on the primary device 104, to control actions associated with the temporary eSIM profiling on the secondary device 102. In an embodiment, the actions may, without any limitation, include enabling SMS, enabling calls, enabling data services, receiving one-time passwords for financial transactions, and/or accessing office resources. In an embodiment, the user interface module 220 may integrate with biometric systems to enhance security by requiring fingerprint or facial recognition for certain actions. Additionally, the user interface module 220 may include analytics features that may provide insights into eSIM usage patterns, helping users optimize their data and call management.

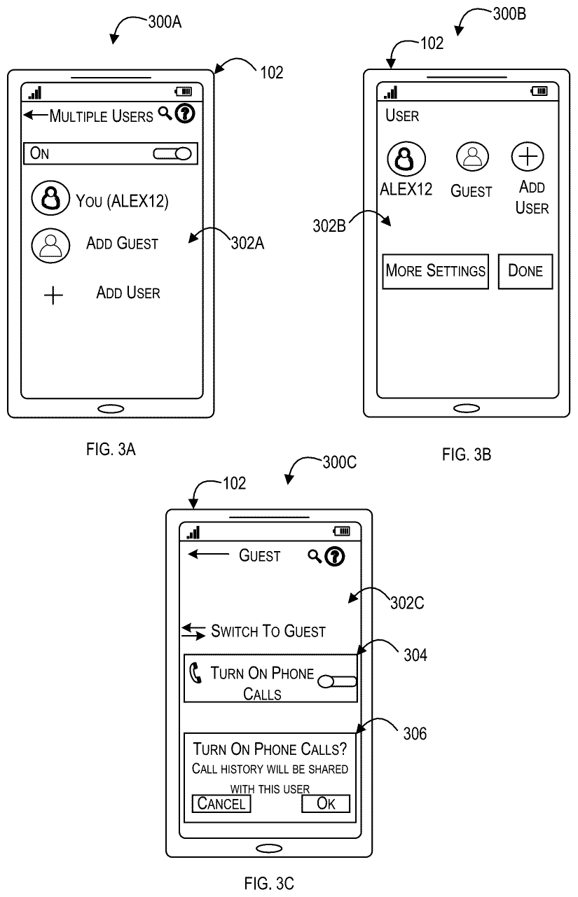

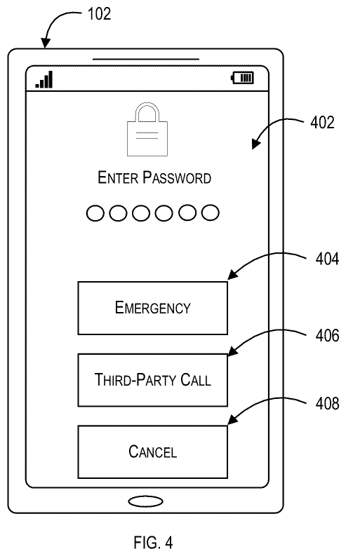

FIG. 3A-C illustrates example screens 300A, 300B, 300C of the secondary user device 102 to enable guest mode, in accordance with an embodiment of the present disclosure. FIG. 4 illustrates an example screen 402 with an option for third-party calls 406 on the locked screen, in accordance with an embodiment of the present disclosure. For the sake of brevity, FIGS. 3A, 3B, 3C, and 4 have been explained together. In an embodiment, the user devices may include an in-built feature, such as “guest mode”, such that by enabling the guest mode on the user device, the user may share the user device with another user without compromising privacy. Accordingly, when the user switches to the guest mode, all the data in the phone may be made inaccessible to the other user. For enabling guest mode of the secondary user device 102, the user may open settings on the device and select the option ‘system’ and then the user may select the option ‘multiple user’ to open a window as shown in 302A of FIG. 3A. Next, the user may toggle on the multiple users ‘ON’ in 302A and select enable the guest mode. Once the guest mode is enabled, the user may provide the user device to any person without providing complete access to the user device. Further, by selecting “more settings” option, the user may create a guest profile for the borrower as shown in 302B of FIG. 3B. When the guest mode is enabled, only default apps in the device may be available to the guest user and that too without any data associated with the secondary user. In this feature, when setting the profile for the guest user, the phone owner may enable an option to make calls by toggling 304 and confirmation 306, as shown in 302C of FIG. 3C. In an embodiment, once the guest mode is enabled, an option to perform a third-party call 406 may even be rendered on the locked screen 402 that may already feature options such as emergency call 404 and cancel 408, as shown in FIG. 4.

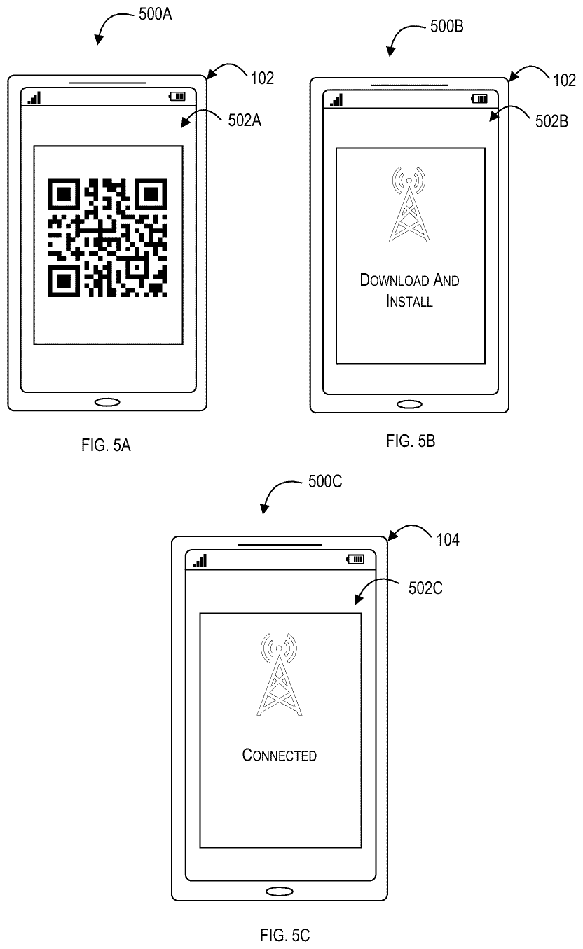

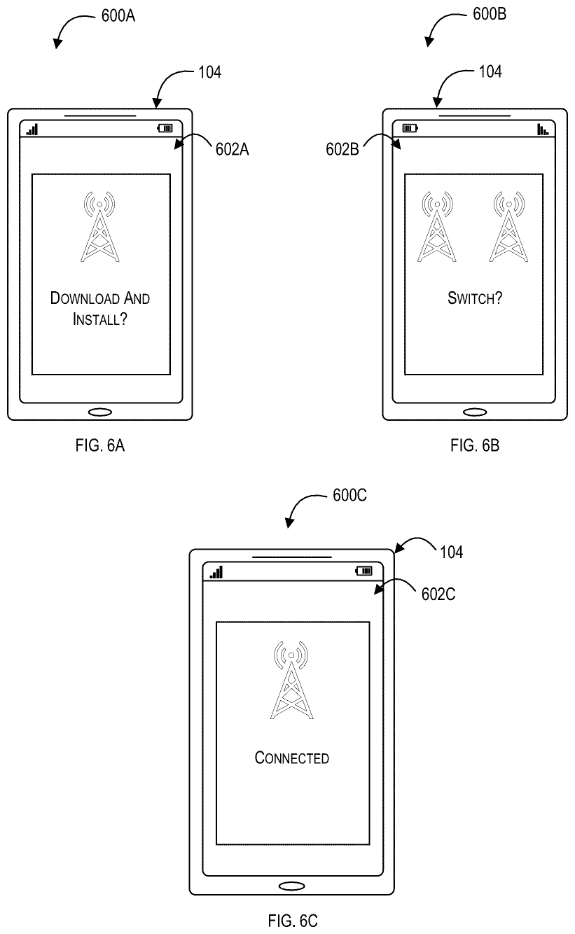

FIG. 5A-C illustrates example screens 500A, 500B, and 500C for operation profile installation on the secondary user device, in accordance with an embodiment of the present disclosure. FIG. 6A-C illustrate example screens 600A, 600B, and 600C for operation profile selection on the secondary user device, in accordance with an embodiment of the present disclosure. It may be apparent to a person skilled in the art that with Remote SIM Provisioning, there are no traditional SIM cards but there is an embedded SIM (called an eUICC), that may be soldered inside the user device and can accommodate multiple SIM profiles. Each profile comprises the operator and subscriber data that may have otherwise been stored on a traditional SIM card. In an embodiment, as illustrated in FIGS. 5A-C, an exemplary operator profile installation of the remote SIM provisioning operation may include the user setting up a contract with the selected mobile network operator to receive instructions on how to connect the device to the operator's Remote SIM Provisioning system. For example, as shown in 502C of FIG. 5A, a QR (Quick Response) code may be used that may contain the address of the remote SIM provisioning system (SM-DP+ server within the GSMA specifications), which allows the device to connect to that system and securely download a SIM Profile, as shown in 502B of FIG. 5B. In an embodiment, once the SIM profile is installed and activated, the device may connect to the corresponding operator's network, as shown in 502C of FIG. 5C. It may be apparent to a person skilled in art that the use of QR codes is one way that the eSIM solution may be configured within the device, and alternatives may, without any limitation, include pre-configured devices, the use of a Subscription Manager Discovery Server, and companion devices, without departing from the scope of the disclosure.

In an embodiment, as illustrated in FIGS. 5A-5C, if the user wishes to change operator, the user may set up a contract with the new operator, and in turn receive a QR code from that operator that may be scanned to locate and download/install the new Profile, as shown in 602A of FIG. 6A. In an embodiment, the user may now be able to switch between the two profiles, as shown in 602B of FIG. 6B. Accordingly, the user device may connect the device to the network of the operator of choice, as shown in 602C of FIG. 6C. It may be apparent to a person skilled in the art that the profile may include the operator data related to a subscription, including the operator's credentials and potentially operator or third-party SIM-based applications. Further, the secure element in the eSIM solution, the eUICC, may accommodate multiple profiles that may be remotely downloaded over the air into an eUICC. In an embodiment, the architecture of the eUICC and its remote provisioning may comply with the requirements of the 3GPP TS 21.133.

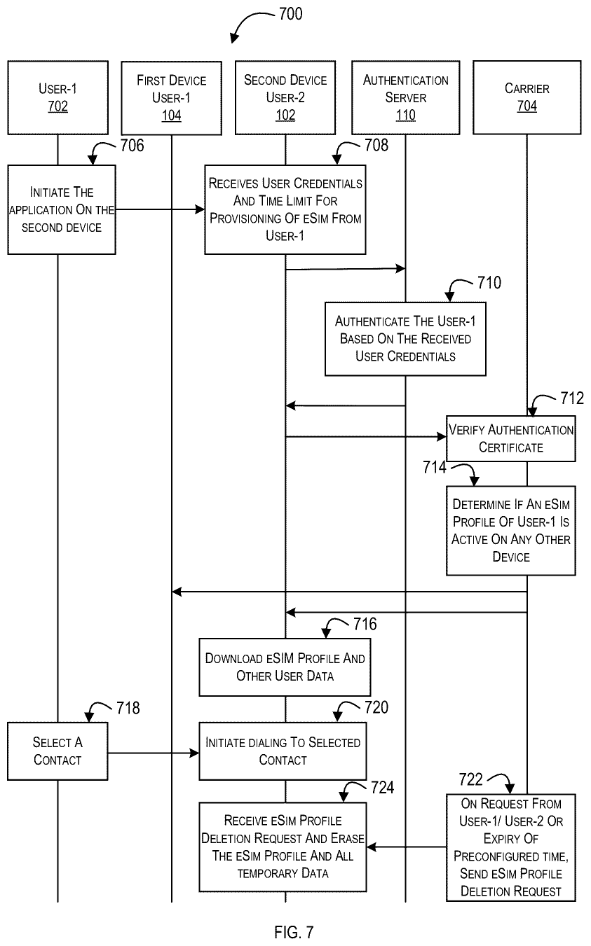

FIG. 7 illustrates a sequence diagram 700 of the system 108 for temporary remote provisioning of the eSIM profile on the secondary device 102, in accordance with an embodiment of the present disclosure.

In an embodiment, making calls from the secondary device 102 or receiving calls at the secondary device 102 may include selection of the third-party call selected by the user-1 702 on the secondary device 102, as shown by the box 706. Next, the system running on the secondary device 102 may ask the user-1 702 to provide credentials (e.g., biometric-id, facial-id, voice-id, user-id, etc.). Upon receiving user credentials and time limit for provisioning of eSIM from the user-1 702, as shown by the box 708, the secondary device 102 may authenticate the identity of the user-1 702 using the first authentication server, such as the mobile OS provider, as shown by the box 710. The system 108 may also receive a carrier ID along with a Subscription Manager Discovery Server (SM-DS) address from the authentication server 110. The system 108 may then send the authentication token from the device-2 to the operator for downloading the profile for user-1 702. In turn, the carrier 704 may trust the authentication token issued by the first authentication server or perform separate user authentication, as shown by the box 712. The carrier 704 may check if the eSIM profile associated with user-1 702 is active on another device, as shown by the box 714. If the eSIM profile is active on another device, the carrier 704 may send an eSIM profile suspension request to the other device and temporarily disable all cellular services for user-1 on the other device. Further, the eSIM profile of user-2 may also be temporarily suspended so that user-1's profile may be pushed on the device if there are limited eSIM profile slots available on device-2. The eSIM profile of user-2 can also be suspended for privacy and security reasons. The subscription manager discovery server may then push the profile (operator data+subscriber data) of user-1 on the mobile device of user-2 based on the received authentication token and/or based on the result of its authentication. The secondary device 102 may then download the eSIM profile as well as other data (e.g., recently dialed number, important contact list, fluid app, etc.) based on pre-configuration, as shown by the box 716. In order to make a call from the profiled eSIM, the user 702 may select a contact 718, and initiate a dialing to the selected contact, as shown by the box 720. In an embodiment, the user-1 702 or user-2 may provide a time limit for which the eSIM profile of user-1 needs to be configured on the secondary device 102. On the expiry of the time limit or on meeting certain pre-configured criteria (e.g., data consumption limit, number of incoming/outgoing call limit, etc.), the carrier may send an eSIM profile suspension or profile deletion request to the secondary device 102, as shown by the box 722. When the user-1 702 may no longer need the secondary device 102, the user may not want to leave any call history or other user data on device-2. Thus, once the purpose of user-1 is served on device-2, based on terminal conditions described earlier, user-1's eSIM profile may be deleted from the secondary device 102 and re-provisioned on their primary device, as shown by the box 724.

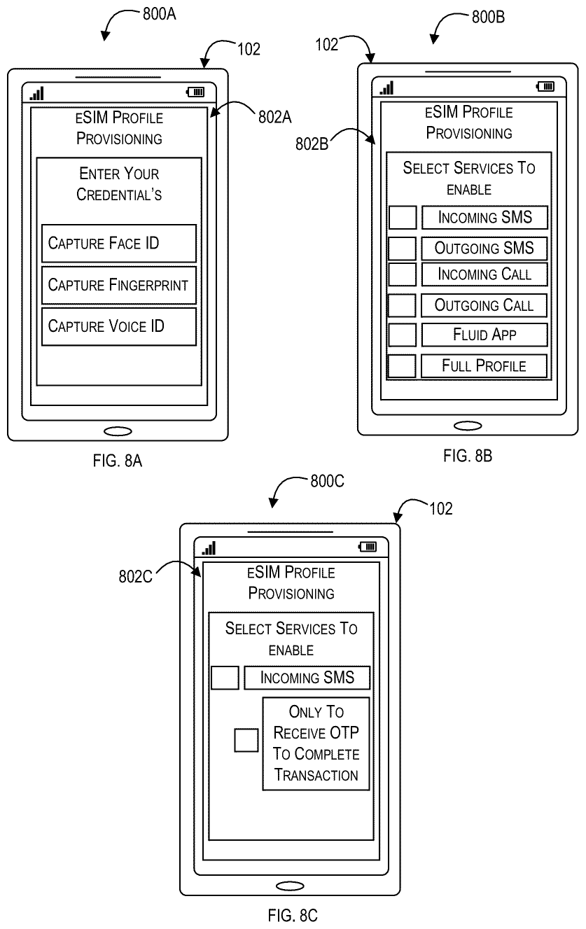

FIG. 8A-C illustrates an example eSIM profile provisioning interface 800A-C, in accordance with an embodiment of the present disclosure. In an embodiment, for receiving and sending SMS or an in-app secure code on the secondary device 102 to verify the user to complete a transaction (e.g., a banking transaction, access to office resources), the user may choose to provision the eSIM profile on the secondary device 102 accessible to the user to capture user credentials, as shown in 802A of FIG. 8A. Once the user enters credentials the verification may be performed by, without any limitation, face ID, fingerprint, and voice ID. Further, the user may be presented with one or more options associated with selecting services for enablement, such as the user may specifically select to provision the eSIM profile just to receive SMS, another in-app code or message, and/or receive a call, as shown in 802B of FIG. 8B. In an embodiment, more granular options may be provided, as shown in 802C of FIG. 8C. For example, an option may be provided to the user to temporarily provision the eSIM profile on a device only for receiving an OTP to complete a financial transaction. The eSIM profile may be provisioned for that purpose, suspending the eSIM profiles of the device owner and the borrower's primary device. Further, as soon as the purpose is served, the borrower's eSIM profile may automatically be deleted and the eSIM profiles of the lender and the borrower may be restored on the primary devices. Before provisioning/activating an eSIM profile on a new device, the system may suspend the eSIM profile on the primary device, and completion of the said purpose activates the eSIM profile back on the primary device.

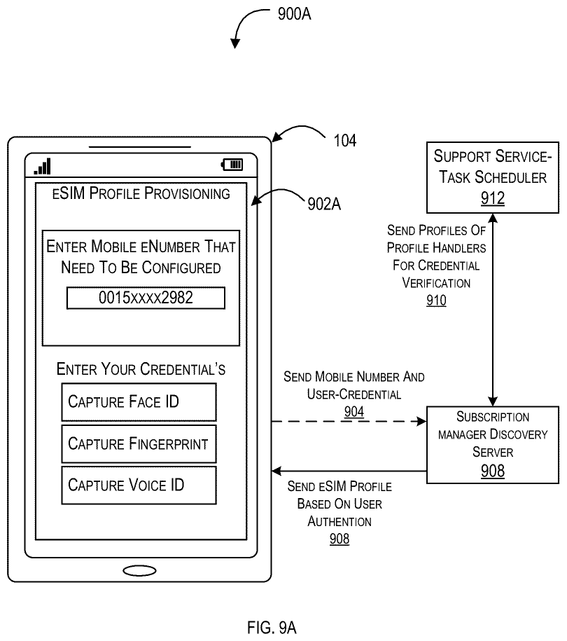

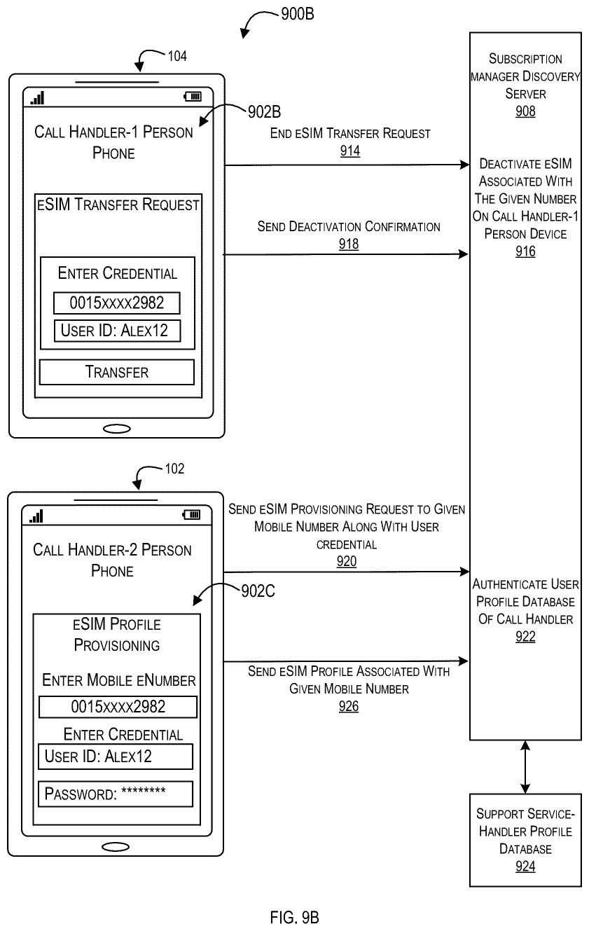

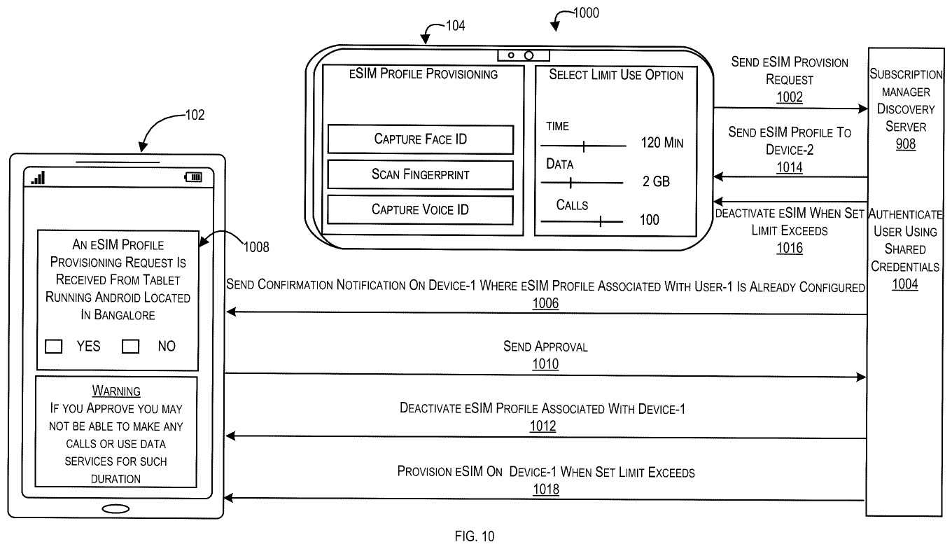

FIG. 9A illustrates an example 900A eSIM configuration on a call handler phone, in accordance with an embodiment of the present disclosure. FIG. 9B illustrates an example 900B of an eSIM transfer request initiated by call handler-1 and eSIM configuration by call handler-2, in accordance with an embodiment of the present disclosure. FIG. 10 illustrates an example 1000 of temporary eSIM provisioning on the second device and auto deactivation when the set limit exceeds, in accordance with an embodiment of the present disclosure. For the sake of brevity, FIGS. 9A, 9B, and 10 have been explained together.

In an embodiment, as illustrated in FIG. 9A, the user easily transfers a mobile number associated with a support service from one personal device to another personal device based on business requirements. For this, the mobile phone may provide an option to temporarily provide a mobile number on a calling device. To request temporary provisioning of a profile associated with a mobile number on a personal calling device, the application may ask the user to enter the mobile number and the user credential, as shown in 902A. The application may determine a carrier/service provider associated with the mobile number and may send the user credential to the profile provisioning server of the carrier i.e. subscription manager discovery server (also termed as carrier server), as shown by 904. The carrier server 908 may authenticate the user based on preconfigured profile 910 responsible for handling calls for the present shift by sending them to the support service task scheduler 912. The carrier server 908 may have received the profile of a user responsible for handling calls at the present shift in advance or by handover request initiated by an earlier call handler. On successful authentication of the user, the carrier server may send the profile associated with the mobile number of the user's device, as shown by 906. In an embodiment, as shown in FIG. 9B, the eSIM provisioning request may be sent to given mobile number along with user credential, as shown by 920, to the subscription manager discovery server 908 by the user from the secondary device 102. The subscription manager discovery server 908 may authenticate the user profile database of call handler 922 and send eSIM associated with given mobile number 926 through support service handler profile database 924. Further, the user from the primary device 104 may send end eSIM transfer request 914 to the subscription manager discovery server 908, such that the subscription manager discover server 908 may deactivate eSIM associated with the given number on call handler-1 personal device 916 and send a deactivation confirmation 918.

In an embodiment, as shown in FIG. 10, the user may temporarily provision an eSIM profile on any device that supports an eSIM slot for enabling voice calls or using data services and to protect against misuse of subscribed cellular or data services associated with the eSIM profile (mobile number) on device-2 104 (such as tablet), user-1 may select for how long they may provide the eSIM profile on device-2. Similarly, user-1 may wish to define how much data can be consumed using the device-2 or how many calls can be initiated from device-2. Such data may be sent to the carrier server 908, as shown by 1002 which in turn may authenticate the user using shared credentials 1004. On successful authentication of user-1, the carrier server 908 may send confirmation notification on device-1 where eSIM profile associated with user-1 is already configured, as shown by 1006. Next, the secondary device may receive a notification regarding eSIM profiling, as shown by 1008. Once the user approves the eSIM profiling, the approval may be sent to the carrier server 908, as shown by 1010, and the eSIM profile may be provisioned on device-2 based on such configuration. When such requests are initiated on device-2, the server may send a notification on device-1 where the eSIM profile may be active and seek specific permission. The eSIM profile can be configured only when the user approves the request on device 1. On completion of the duration, or the defined data limit, or the number of calls, the eSIM profile can be removed from the device-2, as shown by 1016, such that the eSIM profile may be sent back to the primary device, as shown by 1014. Accordingly, eSIM profile associated with device-1 may be deactivated, as shown by 1012 and eSIM may be provisioned back on device-1, as shown by 1018.

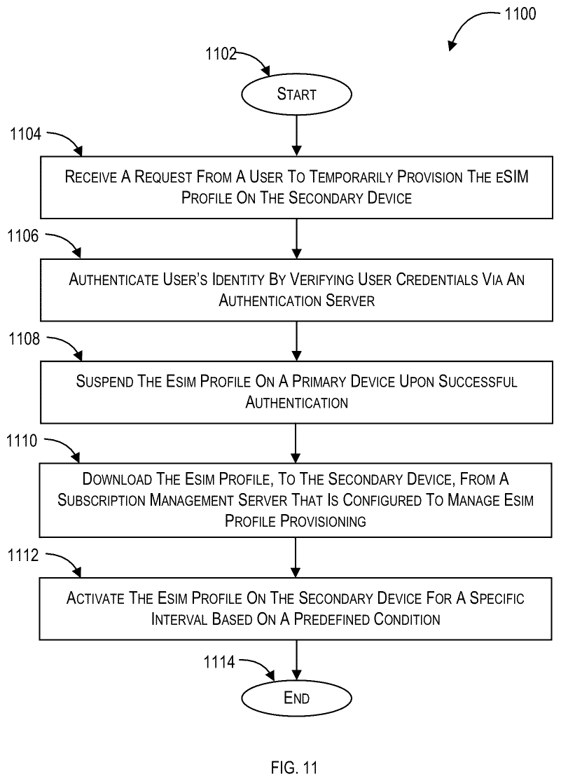

FIG. 11 is a flow chart 1100 of a method for temporary remote provisioning of an electronic Subscriber Identity Module (eSIM) profile on a secondary device, in accordance with an embodiment of the present disclosure. The method starts at step 1102.

At first, a request may be received from a user to temporarily provision the eSIM profile on the secondary device, at step 1104. Next, at step 1106, user's identity may be authenticated by verifying user credentials via an authentication server. The method may also include the steps of prompting the user, on the secondary device, for additional credentials and/or biometric verification before provisioning the eSIM profile. The authentication server may verify user credentials through one or more verification techniques including password, PIN, biometric identification, and/or security questions.

Next, at step 1108, the eSIM profile may be suspended on a primary device upon successful authentication. Next, at step 1110, the eSIM profile may be downloaded to the secondary device from a subscription management server that is configured to manage eSIM profile provisioning. Thereafter, at step 1112, the eSIM profile may be activated on the secondary device for a specific interval based on a predefined condition. The method may also include the steps of deactivating and deleting the eSIM profile from the secondary device and reactivating the eSIM profile on the primary device upon expiration of the specific interval. Further, the predefined condition may include a data consumption limit, a number of incoming/outgoing calls, and/or a user-specified time limit. Also, the method may include the steps of suspending the eSIM profile of a second user on the secondary device if the secondary device has limited eSIM profile slots available.

Additionally, the method may include the steps of facilitating the user, on the primary device, to specify conditions for profiling eSIM on the secondary device. Further, the method may include notifying the user, on the primary device, when the predefined condition for the temporary eSIM profile provisioning on the secondary device set to expire. The method may also include facilitating the user, on the primary device, to controlling actions associated with the temporary eSIM profiling on the secondary device. The actions may include enabling SMS, enabling calls, enabling data services, receiving one-time passwords for financial transactions, and/or accessing office resources.

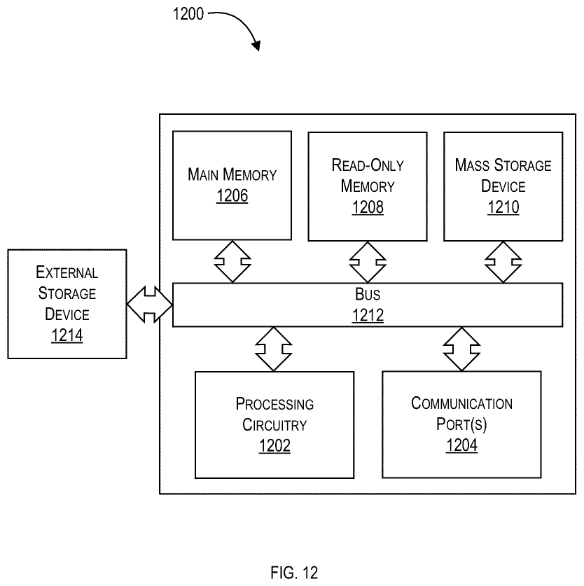

FIG. 12 illustrates an exemplary computer unit in which or with which embodiments of the present disclosure may be utilized. As shown in FIG. 12, a computer system 1200 includes an external storage device 1214, a bus 1212, a main memory 1206, a read-only memory 1208, a mass storage device 1210, a communication port 1204, and a processor 1202.

Those skilled in the art will appreciate that computer system 1200 may include more than one processor 1202 and communication ports 1204. Examples of processor 1202 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 1202 may include various modules associated with embodiments of the present disclosure.

The communication port 1204 can be any of an RS-232 port for use with a modem-based dialup connection, a 10/100 Ethernet port, a Gigabit or 10 Gigabit port using copper or fiber, a serial port, a parallel port, or other existing or future ports. The communication port 1204 may be chosen depending on a network, such as a Local Area Network (LAN), Wide Area Network (WAN), or any network to which the computer system connects.

The memory 1206 can be Random Access Memory (RAM), or any other dynamic storage device commonly known in the art. Read-Only Memory 1208 can be any static storage device(s) e.g., but not limited to, a Programmable Read-Only Memory (PROM) chips for storing static information e.g., start-up or BIOS instructions for processor 1202.

The mass storage 1210 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 1212 communicatively couples processor(s) 1202 with the other memory, storage, and communication blocks. The bus 1212 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 1202 to a software system.

Optionally, operator and administrative interfaces, e.g., a display, keyboard, and a cursor control device, may also be coupled to bus 1212 to support direct operator interaction with the computer system. Other operator and administrative interfaces can be provided through network connections connected through communication port 1204. An external storage device 1310 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

What is claimed is:

1. A system for temporary remote provisioning of an electronic Subscriber Identity Module (eSIM) profile on a secondary device, the system comprising:
a receiving module to receive a request from a user to temporarily provision the eSIM profile on the secondary device;
an authentication module to authenticate user's identity by verifying user credentials via an authentication server;
a suspension module to suspend the eSIM profile on a primary device upon successful authentication;
a profile download module to download the eSIM profile, to the secondary device, from a subscription management server that is configured to manage eSIM profile provisioning; and
a profile activation module to activate the eSIM profile on the secondary device for a specific interval based on a predefined condition.

2. The system as claimed in claim 1, wherein the profile activation module is further configured to deactivate and delete the eSIM profile from the secondary device and reactivate the eSIM profile on the primary device upon expiration of the specific interval.

3. The system as claimed in claim 1, wherein the predefined condition includes at least one of: a data consumption limit, a number of incoming/outgoing calls, and a user-specified time limit.

4. The system as claimed in claim 1, further comprises a user interface module to facilitate the user, on the primary device, to specify conditions for profiling eSIM on the secondary device.

5. The system as claimed in claim 4, wherein the user interface module notifies the user, on the primary device, when the predefined condition for the temporary eSIM profile provisioning on the secondary device set to expire.

6. The system as claimed in claim 4, wherein the user interface module facilitates the user, on the primary device, to controlling actions associated with the temporary eSIM profiling on the secondary device, wherein the actions include at least one of: enabling SMS, enabling calls, enabling data services, receiving one-time passwords for financial transactions, accessing office resources.

7. The system as claimed in claim 1, wherein the authentication module prompts the user, on the secondary device, for at least one of: additional credentials and biometric verification before provisioning the eSIM profile.

8. The system as claimed in claim 1, wherein the profile activation module suspends the eSIM profile of a second user on the secondary device if the secondary device has limited eSIM profile slots available.

9. The system as claimed in claim 1, wherein the primary device and the secondary device communicate via a secure channel to ensure data integrity during the eSIM profile transfer.

10. The system as claimed in claim 1, wherein the eSIM profile includes at least one of: operator credentials, subscriber data, and SIM-based applications.

11. The system as claimed in claim 1, wherein the authentication server verifies user credentials through one or more verification techniques including at least one of: password, PIN, biometric identification, and security questions.

12. The system as claimed in claim 1, wherein the secondary device is selected from a group consisting of a mobile phone, tablet, car infotainment system, and any connected device with an eSIM slot.

13. A method for temporary remote provisioning of an electronic Subscriber Identity Module (eSIM) profile on a secondary device, the method comprising:
receiving a request from a user to temporarily provision the eSIM profile on the secondary device;
authenticating user's identity by verifying user credentials via an authentication server;
suspending the eSIM profile on a primary device upon successful authentication;
downloading the eSIM profile, to the secondary device, from a subscription management server that is configured to manage eSIM profile provisioning; and
activating the eSIM profile on the secondary device for a specific interval based on a predefined condition.

14. The method as claimed in claim 13, further comprising deactivating and deleting the eSIM profile from the secondary device and reactivate the eSIM profile on the primary device upon expiration of the specific interval.

15. The method as claimed in claim 13,
wherein the predefined condition includes at least one of: a data consumption limit, a number of incoming/outgoing calls, and a user-specified time limit;
wherein the primary device and the secondary device communicate via a secure channel to ensure data integrity during the eSIM profile transfer; and
wherein the eSIM profile includes at least one of: operator credentials, subscriber data, and SIM-based applications.

16. The method as claimed in claim 13, further comprises:
facilitate the user, on the primary device, to specify conditions for profiling eSIM on the secondary device;
notifying the user, on the primary device, when the predefined condition for the temporary eSIM profile provisioning on the secondary device set to expire; and
facilitating the user, on the primary device, to controlling actions associated with the temporary eSIM profiling on the secondary device, wherein the actions include at least one of: enabling SMS, enabling calls, enabling data services, receiving one-time passwords for financial transactions, accessing office resources.

17. The method as claimed in claim 13, further comprising prompting the user, on the secondary device, for at least one of: additional credentials and biometric verification before provisioning the eSIM profile.

18. The method as claimed in claim 13, further comprises suspending the eSIM profile of a second user on the secondary device if the secondary device has limited eSIM profile slots available.

19. The method as claimed in claim 13, wherein the authentication server verifies user credentials through one or more verification techniques including at least one of: password, PIN, biometric identification, and security questions.

20. The method as claimed in claim 13, wherein the secondary device is selected from a group consisting of a mobile phone, tablet, car infotainment system, and any connected device with an eSIM slot.
